(19) United States
(12) Patent Application Publication
(10) Pub. No.: US 2016/0355031 A1
(43) Pub. Date: Dec. 8, 2016

(54) METHOD AND DEVICE FOR PRE-TREATMENT OF A RECORDING MEDIUM FOR AN ELECTROPHORETIC TONER TRANSFER

(71) Applicant: Oce Printing Systems GmbH & Co. KG, Poing (DE)

(72) Inventors: Sabine Gerlach, Muenchen (DE); Thomas Montag, Unterhaching (DE); Wolfgang Hettler, Feldkirchen (DE)

(73) Assignee: Oce Printing Systems GmbH & Co. KG, Poing (DE)

(21) Appl. No.: 15/172,610

(22) Filed: Jun. 3, 2016

(30) Foreign Application Priority Data
Jun. 3, 2015 (DE) 102015108811.8

(51) Int. Cl. B41J 11/00; B01D 59/42

(52) U.S. Cl. CPC B41J 11/0015; B01D 59/42

(57) ABSTRACT

A printing system can include an energizer, a condition group, a print group, a sensor, and a controller. The energizer can be configured to treat a surface of a recording medium to increase an energy of the surface. The conditioning group can be configured to provide a coating substance on the surface having been treated by the energizer to provide a pre-treated recording medium having a coated surface. The print group can be configured to print a toner-based print image onto the coated surface of the pre-treated recording medium using electrophoresis. The sensor can be configured to detect resistance data indicative of a resistance of the pre-treated recording medium orthogonal to the coated surface of the pre-treated recording medium. The controller can be configured to control the energizer to adapt a dimension of the increase of the energy of the surface of the recording medium based the resistance data.

### CROSS REFERENCE TO RELATED APPLICATIONS

This patent application claims priority to German Patent Application No. 102015108776.6, filed Jun. 3, 2015, which is incorporated herein by reference in its entirety.

### BACKGROUND

The disclosure is directed to a printing system, in particular a liquid toner printing system, which transfers toner using electrophoresis onto the surface of a recording medium.

A printing system may comprise a conditioning group which pre-treats the surface of a recording medium (which is to be printed to by the printing system) with a coating substance. For example, the adhesion of toner particles onto the surface of the recording medium may be increased via the pre-treatment with the coating substance. Examples of coating substances are described in WO2013/126869A1, DE60016045T2, EP1067433A1, U.S. Pat. No. 3,549,406A. DE69306936T2 describes an electrostatographic printer in which electrostatic charge is applied to the back side of a recording medium via a corona. WO01/95036A1 describes an electrographic printer. U.S. Pat. No. 4,189,643 describes a printer with a corona pre-treatment.

The coating substances typically comprise an active substance via which the adhesion of the toner particles onto the surface of the recording medium may be increased. Furthermore, the coating substances typically comprise an active substance carrier fluid (water, for example) that serves to distribute the active substance as uniformly as possible onto the surface of the recording medium.

A fluid (e.g., a conductive fluid) may pose a problem in the electrophoretic toner transfer process because the fluid may form a separating layer between the recording medium and the applied toner particles. The toner particles may then not enter into a sufficient bond with the recording medium due to the separating layer. This may lead to a return transfer of transfer-printed toner particles in a subsequent print group, and thus to a reduction of the print quality.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a printing system using an example of a roll-to-roll configuration of a digital printer according to an exemplary embodiment of the present disclosure;

FIG. 2 illustrates a pre-treatment device operable to pre-treat a recording medium according to an exemplary embodiment of the present disclosure;

FIG. 3 illustrates a graph of a curve of the resistance of a recording medium depending on the energy quantity of an energy treatment of the recording medium according to an exemplary embodiment of the present disclosure; and

FIG. 4 illustrates a flowchart of a pre-treatment method according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure includes adapting the pre-treatment of the recording medium with a coating substance to increase the print quality of a printing system. Another object is to reduce a degree of the return transfer from a print image in a subsequent print group of the printing system.

According to one aspect of the present disclosure, a printing system is described. The printing system can include an energizer that is set up to increase the energy of a surface of a recording medium. Furthermore, the printing system comprises a conditioning group that is set up to apply a coating substance onto the surface of the recording medium that has been treated with the energizer, and thus to provide a pre-treated recording medium. Moreover, the printing system comprises a print group that is set up to print a toner-based print image onto the pre-treated recording medium by means of electrophoresis. Furthermore, the printing system comprises a sensor that is set up to detect resistance data, wherein the resistance data indicate information with regard to a resistance of the recording medium orthogonal or transversal to the surface of the recording medium. Moreover, the printing system comprises a controller that is set up to induce the energizer to adapt a dimension of the increase of the energy of the surface of the recording medium on the basis of the resistance data.

According to a further aspect, a method is described for the pre-treatment of a recording medium with a coating substance. The method includes the increasing of the energy of a surface of the recording medium in order to provide a treated surface of the recording medium. Moreover, the method includes the application of the coating substance onto the treated surface of the recording medium in order to provide a pre-treated recording medium for the printing of a toner-based print image by means of electrophoresis. Furthermore, the method includes the detection of resistance data, wherein the resistance data indicate information with regard to a resistance of the recording medium orthogonal to the surface of the recording medium. Moreover, the method includes the adaptation of a dimension of the increase of the energy of the surface of the recording medium on the basis of the resistance data.

According to a further aspect, a software (SW) program is described. In an exemplary embodiment, a processor (e.g., a processor of the controller of the printing system) can be configured to execute the SW program to thereby execute one or more exemplary methods described herein.

According to a further aspect, a storage medium is described. The storage medium may include a SW program that can be executed by a processor to thereby execute one or more exemplary methods described herein.

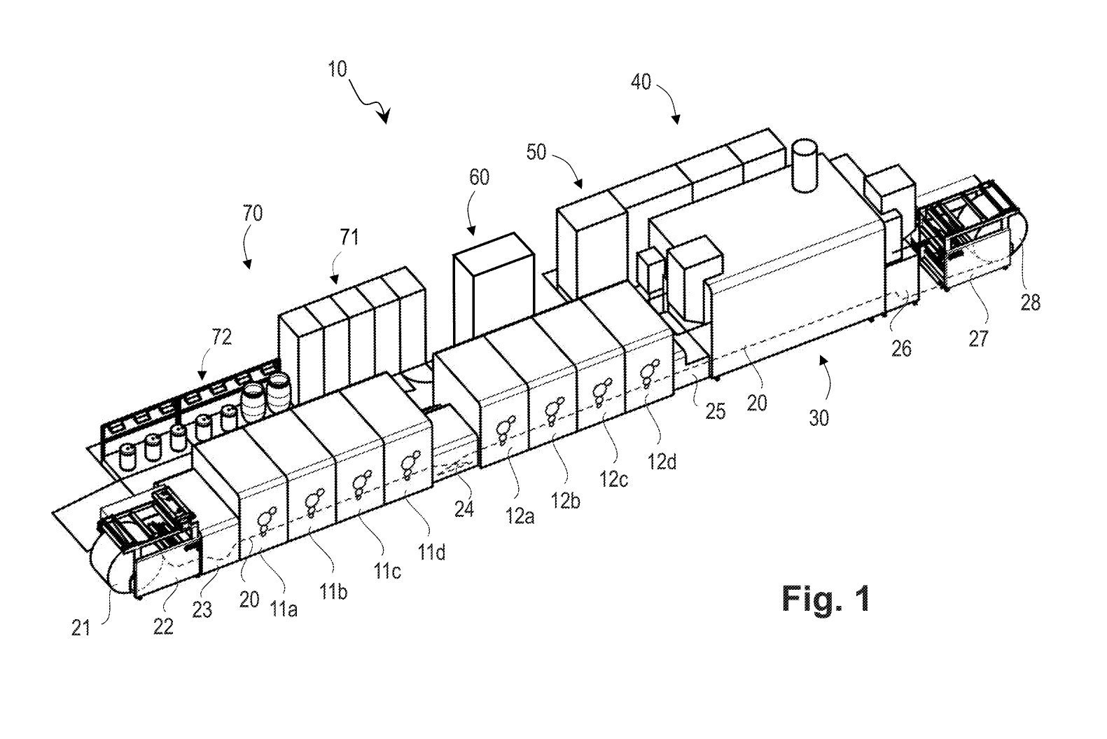

FIG. 1 illustrates a digital printer 10 according to an exemplary embodiment of the present disclosure. The digital printer 10 can be configured to print to a recording medium 20, and can include one or more print groups 11a-11d and 12a-12d that print a toner image onto the recording medium 20.

In an exemplary embodiment, the digital printer 10 is configured to print based on the electrophotographic principle in which a toner transfer in the print groups takes place using electrophoresis. As shown in FIG. 1, a web-shaped recording medium 20 (as a recording medium 20) is unrolled from a roll 21 with the aid of a take-off 22 and is supplied to the first print group 11a. The print image 20′ is fixed on the recording medium 20 in a fixer 30. The recording medium 20 may subsequently be taken up on a roll 28 with the aid of a take-up 27. A configuration depicted in FIG. 1 is also designated as a roll-to-roll printer. Alternatively, the recording medium 20 may be divided up into individual sheets by a cutter or sheet cutter (not shown) at the output of the fixer 30.

In an exemplary embodiment, the web-shaped recording medium 20 is printed to in full color (what is known as a 4/4 configuration) with four print groups 11a through 11d on the front side and with four print groups 12a through 12d on the back side, but is not limited hereto. For example, different configurations are also possible, including, for example, a 7/0 configuration with 7 print groups for the front side and no print group for the back side. For printing, the recording medium 20 is unwound from the roll 21 by the take-off 22 and supplied via a conditioning group 23 to the first print group 11a. In the conditioning group 23, the recording medium 20 is pre-treated or coated with a suitable substance. An active substance is typically contained in the coating substance (also designated as a primer). Furthermore, the coating substance typically comprises an active substance carrier fluid. In particular, the coating substance may comprise an aqueous polymer emulsion.

The recording medium 20 is subsequently supplied in order to the first print groups 11a through 11d, in which only the front side is printed to. Each print group 11a-11d typically prints to the recording medium 20 in a different color or with different toner material, for example, Magnetic Ink Character Recognition (MICR) toner that can be read electromagnetically.

After the printing to the front side, the recording medium 20 may be turned in a turner 24 and be supplied to additional print groups 12a-12d for printing to the back side. In the region of the turner 24, an additional conditioning group (not shown in FIG. 1) may be arranged via which the recording medium 20 is prepared for the printing to the back side. It is thus prevented that the front side print image is mechanically damaged upon further transport through the subsequent print groups.

In an exemplary embodiment, a register 25 is arranged after the print group 12d via which registration marks that are printed onto the recording medium 20 independent of the print image 20′ (in particular outside of the print image 20′) are evaluated. The transversal and longitudinal registration (the primary color dots that form a color dot should be arranged atop one another or spatially very close to one another; this is also designated as color registration or four-color registration) and the register (front side and back side must precisely spatially coincide) can therefore be adjusted so that a qualitatively good print image 20′ is achieved.

In an exemplary embodiment, fixer 30 is arranged after the register 25 via which the print image 20′ on the recording medium 20 is fixed. Arranged after the fixer 30 is a drawing plant 26 that draws the recording medium 20 through all print groups 11a-12d and the fixer 30 without an additional drive being arranged in this region. A friction drive for the recording medium 20 would create the risk that the as of yet unfixed print image 20′ could be smeared.

The drawing plant 26 supplies the recording medium 20 to the take-up 27 that rolls up the printed recording medium 20. Alternatively, the recording medium 20 may be cut into individual printed sheets by a sheet cutter.

In an exemplary embodiment, centrally arranged in the print groups 11, 12 and the fixer 30 are one or more supply devices for the digital printer 10, such as climate control fixer modules 40, power supply 50, controller 60, fluid management modules 70 (such as fluid controller 71 and reservoirs 72 of the different fluids). In an exemplary embodiment, pure carrier fluid, highly concentrated liquid developer (higher proportion of toner particles in relation to the carrier fluid) and serum (toner carrier fluid plus charge control substances) are used as fluids in order to supply the digital printer 10, as well as waste containers for the fluids to be disposed of or containers for cleaning fluid. In one or more exemplary embodiments, the controller 60 and/or the fluid controller 71 can include processor circuitry configured to perform one or more of their respective functions.

In an exemplary embodiment, the recording medium 20 may be made of paper, paperboard, cardboard, metal, plastic and/or other suitable and printable materials. In particular, the recording medium 20 can be configured to take up or absorb the active substance carrier fluid of a coating substance.

In an exemplary embodiment, as illustrated in FIG. 1, the printing system 10 may include a plurality of print groups 11a, 11b, 11c, 11d. This may lead to the situation that the print image which was applied by a first print group 11a onto the recording medium 20 is at least partially removed by a subsequent second print group 11b. This can lead to a reduction of the print quality and to a contamination of the subsequent second print group 11b. Such a return transfer may in particular occur given the use of a conditioning group 23 and via the application of coating substance onto the recording medium 20. While the active substance of the coating substance typically leads to an increased adhesion of the toner particles onto the recording medium 20 in the first print group 11a, the active substance carrier fluid may form a separating layer between toner particles and recording medium, which may lead to the situation that a return transfer of the toner particles from the recording medium 20 onto the transfer roller of the second print group 11b occurs given electrophoretic transfer in the second print group 11b. This effect may be observed in particular when the active substance carrier fluid of the coating substance has not yet been absorbed sufficiently into the recording medium.

In an exemplary embodiment, to reduce and/or eliminate negative influences of the active substance carrier fluid, the recording medium 20 coated with the coating substance may be dried before the printing in the first print group 11a in order to remove the active substance carrier fluid. However, this may cause the recording medium 20 to shrink in the drying of the recording medium 20, which may cause issues in positioning of the print image on the recording medium 20. Furthermore, drying typically is implemented outside of the printing system 10 (i.e. offline), which can lead to an increase in the printing costs (for example due to storage and/or due to a reduction of the print speed). Moreover, the adhesive effect of the coating substance may be reduced by the drying.

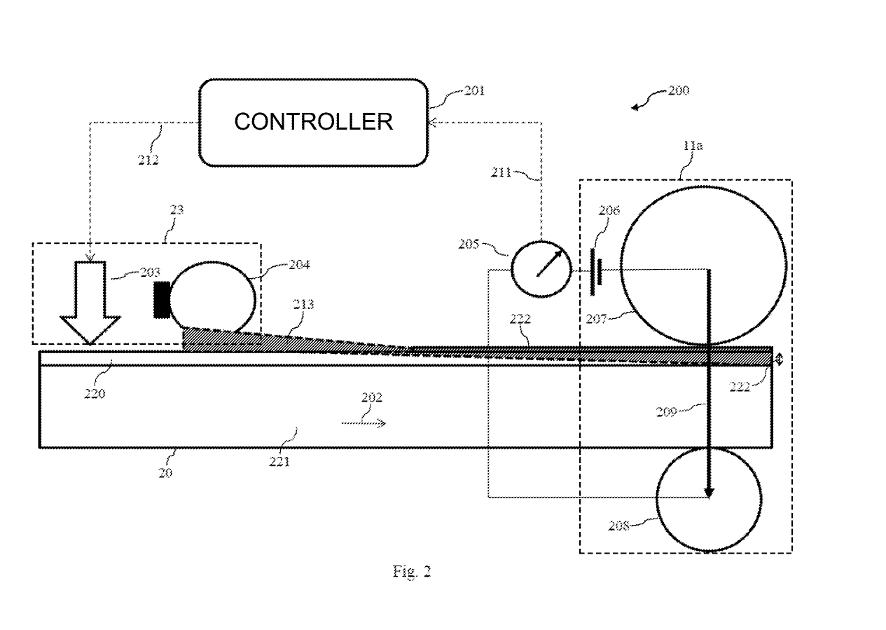

FIG. 2 illustrates a pre-treatment device 200 configured to pre-treat a recording medium 20 according to an exemplary embodiment of the present disclosure. In an exemplary embodiment, the pre-treatment device 200 can be configured to increase a surface energy and/or a surface tension of the recording medium 20. In this example, the pre-treatment device 200 may include an energizer 203 configured to increase the surface energy and/or the surface tension of the recording medium 20. In an exemplary embodiment, the energizer 203 can be configured to generate a corona and/or a plasma that are directed towards the surface of the recording medium 20, and to thereby increase the surface energy and/or the surface tension of the recording medium 20. In an exemplary embodiment, a dimension/amount of the surface energy added to the recording medium 20 may be adapted, (e.g., increased or reduced). The increase of the surface energy and/or the surface tension can cause an increase of the temperature of the recording medium 20 (at least locally at the treated surface of the recording medium 20).

In an exemplary embodiment, after increasing the surface energy (for example via a roller 204 of the conditioning group 23), the coating substance 213 may be applied onto the surface of the recording medium 20. Via the preceding increase of the surface energy of the recording medium 20, it may be achieved that the absorption of the active substance carrier fluid into the recording medium 20 (in particular into a coating 220 of the recording medium 20) is accelerated. In an exemplary embodiment, coating 220 can include one or more layers at the surface of the recording medium 20. For example, the one or more layers are provided with a binding agent in order to finish the surface of the recording medium 20. An uncoated layer 221 of the recording medium 20 (for example the raw paper) is typically arranged below these one or more coated layers.

In an exemplary embodiment, by increasing the surface energy of the recording medium 20 it may be achieved that the active substance carrier fluid is already (nearly) entirely located in the coating 220 or in a layer on the surface of the recording medium 20 upon reaching the first print group 11a (see transport direction 202 of the recording medium 20 in FIG. 2). It may thereby be ensured that the active substance carrier fluid does not have an interfering effect (or the effect is reduced) on the printing of the print images in the following print groups 11a, 11b of the printing system 10. As demonstrated in the following, a positive effect on the electrophoretic toner transfer may also be produced via the active substance carrier fluid that has been absorbed into the coating 220 or into a layer on the surface.

In an exemplary embodiment, the side of the recording medium 20 that is to be printed to may thus be charged with ions (by a corotron, for example) and/or with a plasma before the application of the coating substance 213 (i.e. before the priming). The surface tension and/or the surface energy of the side of the recording medium 20 that is to be printed to hereby increase. This is particularly advantageous given the use of coated recording media 20 (with at least one coating 220), but may also be used given uncoated recording media 20.

In an exemplary embodiment, the increase of the surface tension and/or the surface energy of the side of the recording medium 20 that is to be printed to causes the active substance carrier fluid to be absorbed more quickly into the recording medium 20. In this example, a layer 222 that can include a functional primer substance may form directly on the surface of the recording medium 20 without a separating layer, or given a markedly reduced separating layer made up of active substance carrier fluid, and thus is present for the following printing process.

In an exemplary embodiment, due to the absorption of the active substance carrier fluid (water, for example) into the recording medium 20, the electrical resistance in the coating 220 or in a layer on or near the surface of the recording medium 20 is reduced. This has advantages for the subsequent one or more print groups 11a, 11b because an electrical field 209 with a higher field strength may be realized due to the reduced resistance of the recording medium 20, in particular due to the reduced resistance of the coating 220. The toner transfer from a transfer roller 207 of a print group 11a onto the recording medium 20 is hereby more efficient and economical.

In an exemplary embodiment, the device 200 includes a controller 201 that is configured to control and/or regulate the energy quantity applied onto the surface of the recording medium 20 by the energizer 203. In an exemplary embodiment, the controller 201 includes processor circuitry configured to perform one or more functions of the controller 201, including, for example, controlling and/or regulating the energy quantity applied on the recording medium 20. In an exemplary embodiment, the energy quantity can include the amount of energy applied (e.g., quantity, duration of application, etc.) and/or the intensity of the energy applied, but is not limited hereto.

In an exemplary embodiment, the controller 201 is configured to determine resistance data/information 211 corresponding to a resistance of the recording medium 20. The resistance data/information 211 can correspond to the volume resistance or forward resistance of the recording medium 20. In an exemplary embodiment, the resistance data 211 may indicate the volume resistance or forward resistance of the recording medium 20 orthogonal to the transport direction 202 through the recording medium 20. In an exemplary embodiment, the controller 201 can determine resistance data 211 between the transfer roller 207 and the counter-pressure roller 208 and/or between a different roller pair, for example.

In an exemplary embodiment, a print group 11a of the printing system 10 includes a power supply 206 configured to generate an electrical field 209 between the transfer roller 207 and a counter-pressure roller 208 of the print group 11a. The current that flows through the recording medium 20 between the transfer roller 207 and the counter-pressure roller 208 due to the electrical field 209 may be measured using the sensor 205 (e.g., a current sensor). In an exemplary embodiment, the magnitude of this current (in connection with the voltage provided by the power supply 206) is an indicator of the resistance of the recording medium 20 and may be provided as resistance data 211 to the controller 201.

In an exemplary embodiment, the controller 201 can be configured to determine and generate control signal 212 based on the resistance data 211. In an exemplary embodiment, the energizer 203 can produce an energy quantity that is applied to the recording medium 20 such that the resistance of the recording medium 20 is reduced (and/or minimized) based on the control signal 212. In an exemplary embodiment, a control loop may be provided for this purpose. In an exemplary embodiment, the controller 201 can determine a control error based on the resistance data 211. For example, the control error can be determined based on the difference between a current resistance value and a preceding resistance value. In an exemplary embodiment, an increase or a reduction of the energy quantity to be generated by the energizer 203 may then be produced based on the control error. A model of the controlled section between the energizer 203 and the sensor 205 may be taken into account in the determination of the control error.

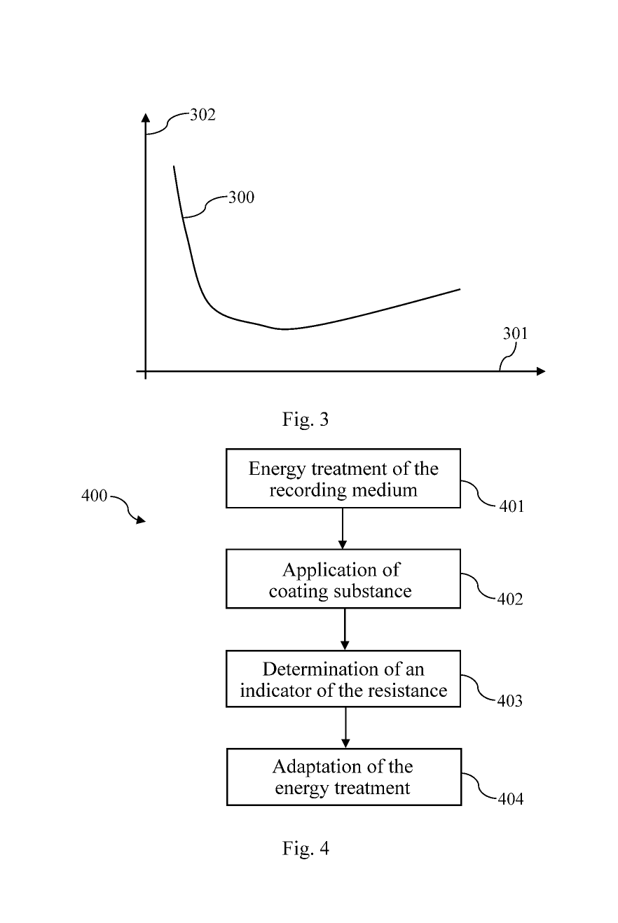

FIG. 3 illustrates a correlation curve 300 between the resistance 302 of the recording medium 20 and the energy quantity 301 applied by the energizer 203. The resistance 302 of the recording medium 20 initially decreases with an increasing energy quantity 301. This initial decrease can be ascribed to the fact that a greater proportion of the active substance carrier fluid penetrates into the coating 220 of the recording medium 20 with an increasing energy quantity 301. After achieving a minimum (e.g., ideal state), the resistance 302 then increases with increasing energy quantity 301. This is to be ascribed to the fact that the active substance carrier fluid penetrates further into the recording medium 20 with increasing energy quantity 301, and the concentration of the active substance carrier fluid in the coating 220 is thereby reduced. In an exemplary embodiment, the energy quantity 301 applied by the energizer 203 can be regulated such that the resistance 302 of the recording medium 20 is at the minimum. It may thus be ensured that the active substance carrier fluid has (nearly) completely been absorbed into the coating 220 of the recording medium 20. Furthermore, it may thus be ensured that the active substance carrier fluid does not penetrate too far into the recording medium 20. In particular, it may thus be ensured that an electrical field 209 with high (e.g., an optimal) field strength is present in the subsequent print groups 11a, 11b for the toner transfer. The efficiency of the electrophoretic toner transfer may thus be increased. Moreover, a return transfer of toner particles may be reduced due to the complete absorption of the active substance carrier fluid.

In an exemplary embodiment, the dose of corona and/or plasma that is generated by the energizer 203 may thus be regulated. In an exemplary embodiment, the electrical resistance 302 of the recording medium 20 changes depending on to what extent the active substance carrier fluid has distributed uniformly in the volume of the coating 220 of the recording medium 20. This resistance 302 has a direct effect on the current flow in the transfer printing point of a print group 11a (e.g., at the nip of the transfer roller 207). For example, if the dose is too low, the active substance carrier fluid insufficiently penetrates into the volume of the coating 220 of the recording medium 20. As a result, only a slight increase in the measured current flow appears. On the other hand, if the dose is too high, although a high proportion of the active substance carrier fluid is absorbed into the recording medium 20, a certain proportion of the active substance carrier fluid already migrates below the coating 220 of the recording medium 20 into the inside of the recording medium 20. The total quantity of absorbed active substance carrier fluid is hereby no longer provided to the original high-resistance coating 220 of the recording medium 20. This can cause the resistance 302 of the recording medium 20 to be higher compared to the minimum possible resistance that is achieved if the available quantity of active substance carrier fluid is distributed uniformly (possibly exclusively) in the coating 220 of the recording medium.

In an exemplary embodiment, as has already been demonstrated, the coating substance 213 can include one or more active substances and an active substance carrier fluid. The one or more active substances may have particles with a diameter that is greater than a pore size of the substrate coating 220. It may thus be ensured that the active substance particles remain on the surface of the recording medium 20 and thus form an effective layer 222.

In an exemplary embodiment, the active substance carrier fluid may be conductive. As an example, the active substance carrier fluid may be water or include water. In particular, however, the active substance carrier fluid may have a conductivity that is greater than the conductivity of water. The effect of the reduction of the resistance 302 of the recording medium 20 may thus be further enhanced.

FIG. 4 illustrates a flowchart of a pre-treatment method 400 according to an exemplary embodiment of the present disclosure. The pre-treatment method 400 can pre-treat a recording medium 20 with a coating substance 213. In an exemplary embodiment, the method 400 includes the increase 401 of the energy of a surface of the recording medium 20 in order to provide a treated surface of the recording medium 20. For example, the energy of the surface may be increased via a corona treatment and/or via a plasma treatment of the surface of the recording medium.

In an exemplary embodiment, the method 400 additionally includes the application 402 of the coating substance 213 onto the treated surface of the recording medium 20 in order to provide a pre-treated recording medium 20 for the printing of a toner-based (in particular a liquid toner-based) print image using electrophoresis. In an exemplary embodiment, the coating substance 213 can include an active substance and an active substance carrier fluid. To enable an effective toner transfer in a subsequent print group, the active substance carrier fluid can be absorbed as completely as possible into the recording medium 20 (if possible into a coating 220 of the recording medium 20).

In an exemplary embodiment, the method 400 additionally includes the detection 403 of resistance data 211. The resistance data 211 can indicate information with regard to a resistance 302 of the recording medium 20 orthogonal or transversal to the surface of the recording medium 20. For example, the magnitude of a current transversally through the recording medium 20 may be measured upon application of a voltage. Given knowledge of the value of the voltage, the magnitude of the current indicates the value of the resistance 302 of the recording medium 20.

In an exemplary embodiment, the method 400 additionally includes the adaptation 404 of a dimension of the increase of the energy of the surface of the recording medium 20 on the basis of the resistance data 211. In particular, the dimension of the increase of the energy (i.e. the dose of the corona treatment and/or of the plasma treatment that is used, for example) may be determined such that the resistance 302 of the recording medium 20 is reduced (possibly minimized). As complete an absorption as possible of the active substance carrier fluid into a coating 220 of the recording medium 20, and therefore a more effective toner transfer and/or as low a degree of toner return transfer as possible, may thus be ensured.

In one or more exemplary embodiments, a printing system 10 includes an energizer 203 that is configured to increase the energy of the surface of a recording medium 20. For this purpose, the energy quantity 301 that is supplied to the recording medium 20 may be adapted. In particular, the energizer 203 can be configured to charge the surface of the recording medium 20 with a corona and/or with a plasma. A dose of the corona and/or of the plasma may thereby be adapted in order to adapt the dimension of the increase of the energy of the surface of the recording medium 20. The controller 201 can be configured to adapt the dose.

In one or more exemplary embodiments, the printing system 10 includes a conditioning group 23 that is configured to apply a coating substance 213 onto the surface of the recording medium 20 that has been treated with the energizer 203, and thus to provide a pre-treated recording medium 20. In an exemplary embodiment, the coating substance 213 thereby includes an active substance that is configured to increase the adhesion of the toner-based (in particular the liquid toner-based) print image onto the recording medium 20, and an active substance carrier fluid (e.g., water based fluid) that is configured to distribute the active substance on the surface of the recording medium 20.

In an exemplary embodiment, the printing system 10 includes at least one print group 11 that is configured to print a toner-based (in particular a liquid toner-based) print image onto the pre-treated recording medium 20 using electrophoresis. The toner transfer may be improved via the coating substance 213 (in particular via the active substance). On the other hand, the toner transfer (in particular in a subsequent print group 11) and/or a return toner transfer may be caused by the active substance carrier fluid.

In an exemplary embodiment, the printing system 10 includes a sensor 205 (e.g., current sensor) that is configured to detect/measure resistance data 211. The resistance data 211 indicates information with regard to a resistance 302 of the recording medium 20 orthogonal or transversal to the surface of the recording medium 20. The print group 11 may include a transfer roller 207 to transfer the toner-based (in particular the liquid toner-based) print image onto the surface of the recording medium 20, and a counter-pressure roller 208. The toner-based print image may be transferred using an electrical field 209 between the transfer roller 207 and the counter-pressure roller 208. This electrical field 209 may be generated by a power supply 206, for example. The sensor 205 may be configured to determine the magnitude of the current through the recording medium 20, which current is produced by the electrical field 209. The resistance data 211 may then include the magnitude of the current as an indicator of the resistance 302 of the recording medium 20.

In an exemplary embodiment, the printing system 10 includes controller 201 that is configured to induce/control the energizer 203 to adapt a dimension of the increase of the energy of the surface of the recording medium 20 based on the resistance data 211. In particular, the dimension of the increase of the energy of the surface of the recording medium 20 may be adapted such that the resistance 302 of the recording medium 20 is reduced (possibly minimized). Via the adaptation of the energy of the surface of the recording medium 20, it may be ensured that the coating substance 213 is applied as optimally as possible onto the surface of the recording medium 20 in order to thus improve the downstream toner transfer. In particular, it may be achieved that the active substance carrier fluid penetrates as completely as possible into a coating 220 of the recording medium 20.

In an exemplary embodiment, the recording medium 20 may have an outer first layer and an underlying second layer parallel to the surface. In an exemplary embodiment, in the dry state, the first layer has a higher resistance than the second layer. For example, the first layer may be a coating 220 of a paper- or cardboard-based recording medium 20. The first layer and the second layer may be configured to absorb a water-based active substance carrier fluid of the coating substance 213. Given a recording medium 20 of such a design, the resistance 302 typically decreases orthogonal to the surface if the active substance penetrates into the first layer. In an exemplary embodiment, a minimum of the resistance 302 can be typically achieved if the active substance carrier fluid is located nearly exclusively in the first layer. On the other hand, a transfer of active substance carrier fluid into the second layer leads again to an increase in the resistance 302 since the resistance-decreasing influence of the active substance carrier fluid is greater in the first layer than in the second layer. In an exemplary embodiment, the first layer may include one or more coatings 220 that are arranged on a second layer made up of raw paper 221.

In an exemplary embodiment, the controller 201 can be configured to determine a model of a controlled section of the printing system 10. The controlled section can include the energizer 203, the conditioning group 23 and the recording medium 20. Furthermore, the controller 201 can be configured to determine a value of a control error on the basis of the resistance data 211. The control error may thereby be determined on the basis of resistance data 211 detected at different points in time. In particular, a difference of resistances 302 may be determined in order to determine whether an increase or a reduction of the resistance 301 was produced by a past change of the dimension of the increase of the energy of the surface of the recording medium 20. In an exemplary embodiment, the controller 201 can be configured to determine the dimension of the increase of the energy of the surface of the recording medium 20 on the basis of the model of the controlled section, and on the basis of the control error. For example, the dimension may be reduced if the control error indicates that a past increase of the dimension has led to an increase of the resistance. On the other hand, the dimension may be further increased if the control error indicates that a past increase of the dimension has led to a reduction of the resistance. A continuously high quality of the toner transfer may be achieved via the provision of a regulation of the energy treatment of the surface of the recording medium 20.

In an exemplary embodiment, the active substance of the coating substance 213 may have particles with a diameter that is greater than a diameter of pores of the surface of the recording medium 20. It may thus be produced that the active substance reliably remains on the surface of the recording medium 20. In an exemplary embodiment, alternatively or additionally, the active substance may have a conductivity that is greater than the conductivity of water. The resistance of the recording medium 20 may thus be further reduced, which is advantageous to the toner transfer.

A pre-treatment (that is insensitive to the recording medium 20) by means of ion charging before the application of the coating substance 213 leads to a targeted separation of the components of the coating substance 213, in particular to a separation of the functional active substance and the active substance carrier fluid. It may thereby be achieved that the functional active substance remains directly on the surface of the recording medium 20, and thus may have optimal effect. The active substance carrier fluid is absorbed into the recording medium 20 and thereby improves the electrical transfer in one or more print groups 11a, 11b of the printing system 10.

Furthermore, the active substance carrier fluid is absorbed into the recording medium 20 immediately before the printing in the one or more print groups 11a, 11b. A larger portion of the absorbed active substance is thus still located in the coating 220 of the recording medium 20. This coating 220 typically has high resistance in the dry state (in comparison to one or more other layers of the recording medium 20). The coating 220 of the recording medium 20 may thus be conditioned via the pre-treatment with ions, which enables it to increase the field strength of the electrical field 209 in the transfer printing nip of a subsequent print group 11a. In an exemplary embodiment, the field strength of the electrical field 209 in the transfer printing nip may be increased via the use of conductivity additives that are absorbed as well in dissolved form into the recording medium 20.

In an exemplary embodiment, the current flows in the transfer printing points may be measured by a sensor 205 in one or in multiple of the print groups 11a, 11b of the printing system 10. These currents indicate the resistance 302 of the recording medium 20 and may be used to regulate the dose of applied ions. The complete absorption of the active substance carrier fluid into the recording medium 20 may thus be reliably produced.

In an exemplary embodiment, alternatively or additionally, the sensor 205 can be configured to determine the resistance data 211 at a different point than the transfer printing point of a print group 11a, 11b. For example, a voltage may be applied between a dedicated roller pair which, for example, is arranged before a print group 11a, 11b and through which the recording medium 20 is directed. The current between the roller pair may then be determined, wherein the current in turn indicates the resistance 302 of the recording medium 20.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 printing system, in particular digital printer
11, 11a-11d print group (front side)
12, 12a-12d print group (back side)
20 recording medium
21 roll (input)
22 take-off
23 conditioning group
24 turner
25 register
26 drawing group
27 take-up
28 roll (output)
30 fixer
40 climate control module
50 power supply
60 controller
70 fluid management
71 fluid controller
72 reservoir
200 device for adaptation of the surface energy of a recording medium
201 controller
202 transport direction of the recording medium
203 energizer
204 roller of the conditioning group
205 sensor
206 power supply
207 transfer roller
208 counter-pressure roller
211 resistance data
212 control signal
213 coating substance
220 coating of the recording medium
221 uncoated layer of the recording medium
222 layer with active substance
300 curve of the resistance
301 energy quantity
302 resistance
400 method for pre-treatment of a recording medium with a coating substance
401, 402, 403, 404 method steps

What is claimed is:

1. A printing system, comprising:
an energizer configured to treat a surface of a recording medium to increase an energy of the surface of the recording medium;
a conditioning group configured to provide a coating substance on the surface of the recording medium having been treated by the energizer to provide a pre-treated recording medium having a coated surface;
a print group configured to print a toner-based print image onto the coated surface of the pre-treated recording medium using electrophoresis;
a sensor configured to detect resistance data indicative of a resistance of the pre-treated recording medium orthogonal to the coated surface of the pre-treated recording medium; and
a controller configured to control the energizer to adapt a dimension of the increase of the energy of the surface of the recording medium based the resistance data.

2. The printing system according to claim 1, wherein the energizer is configured to:
charge the surface of the recording medium with at least one of a corona and a plasma; and
adapt a dose of the at least one of the corona and the plasma to adapt the dimension of the increase of the energy of the surface of the recording medium.

3. The printing system according to claim 1, wherein:
the print group includes: a transfer roller configured to transfer the toner-based print image onto the coated surface of the pre-treated recording medium, and a counter-pressure roller;
the toner-based print image is transferred using an electrical field generated between the transfer roller and the counter-pressure roller;
the sensor is configured to determine a magnitude of a current through the pre-treated recording medium that is produced via the electrical field; and
the resistance data includes the magnitude of the current.

4. The printing system according to claim 1, wherein at least one of:
the coating substance includes: an active substance configured to increase an adhesion of the toner-based print image on the recording medium, and an active substance carrier fluid configured to distribute the active substance on the surface of the recording medium;
the active substance includes particles with a diameter that is greater than a diameter of pores of the surface of the recording medium; and
the active substance carrier fluid has a conductivity that is greater than a conductivity of water.

5. The printing system according to claim 1, wherein the controller is configured to:
determine a model of a controlled section of the printing system, the controlled section including the energizer, the conditioning group, and the recording medium;
determine a value of a control error based on the resistance data; and
determine the dimension of the increase of the energy of the surface of the recording medium based on the model of the controlled section and the control error.

6. The printing system according to claim 5, wherein the control error is determined based on a first resistance data of resistance data and a second resistance data of the resistance data, wherein the first resistance data and the second resistance data being detected at different points in time.

7. The printing system according to claim 1, wherein the controller is configured to determine the dimension of the increase of the energy of the surface of the recording medium such that the resistance of the pre-treated recording medium is reduced.

8. The printing system according to claim 1, wherein:
the recording medium includes an outer first layer and a second layer underlying the outer first layer, the outer first layer and the second layer being parallel to the surface;
in the dry state, the first layer has a higher resistance than the second layer; and
the first layer and the second layer are configured to absorb a water-based active substance carrier fluid of the coating substance.

9. A method for pre-treating a recording medium with a coating substance, the method comprising:
increasing an energy of a surface of the recording medium to provide a treated surface of the recording medium;
applying the coating substance onto the treated surface of the recording medium to provide a pre-treated recording medium with a coated surface, the pre-treated recording medium with the coated surface being operable to have a toner-based print image printed thereon using electrophoresis;
detecting resistance data indicative of a resistance of the pre-treated recording medium orthogonal to the coated surface of the pre-treated recording medium; and
adapting a dimension of the increase of the energy of the surface of the recording medium based on the resistance data.

10. A non-transitory computer-readable storage medium with an executable program stored thereon, wherein the program instructs a processor to perform the method of claim 9.

11. A printing system, comprising:
an energizer configured to charge a surface of a recording medium;
a conditioning group configured to apply a coating substance on the surface of the recording medium having been energized by the energizer to provide a pre-treated recording medium having a coated surface;
a print group configured to print a print image onto the coated surface of the pre-treated recording medium;
a sensor configured to determine a resistance of the pre-treated recording medium; and
a controller configured to control the energizer, based on the resistance detected by the sensor, to adjust a charge value at which the energizer charges the surface of the recording medium.

12. The printing system according to claim 11, wherein the sensor is configured to measure a current through the pre-treated recording medium to determine the resistance.

13. The printing system according to claim 12, wherein:
the print group includes: a transfer roller configured to transfer a print image onto the coated surface of the pre-treated recording medium, and a counter-pressure roller positioned on an opposite side of the pre-treated recording medium; and
the current flows between the transfer roller and the counter-pressure roller.

14. The printing system according to claim 12, wherein:
the printing system further includes a first roller positioned adjacent to the surface of the pre-treated recording medium and a second roller positioned on an opposite side of the pre-treated recording medium; and
the current flows between the first and the second rollers.

15. The printing system according to claim 13, wherein the first and the second rollers are positioned upstream of the print group in a print direction of the recording medium.
